(19) United States
(12) Patent Application Publication
(10) Pub. No.: US 2006/0237999 A1
(43) Pub. Date: Oct. 26, 2006

(54) Coupling structure of hood lock

(75) Inventor: Yutaka Sasaki, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/406,406

(22) Filed: Apr. 19, 2006

(30) Foreign Application Priority Data
Apr. 20, 2005 (JP) 2005-122860

(51) Int. Cl. B62D 25/08

(52) U.S. Cl. 296/203.02

(57) ABSTRACT

A radiator core support has right and left bolt holes. A bracket is fixed to the radiator core support and has a pin projecting toward the radiator core support. A hood lock has an upper portion with upper right and left through-holes and a lower portion, insertable between the radiator core support and the bracket, with a lower through-hole surrounded by a wall portion. The hood lock is coupled on the radiator core support so that the upper portion is fastened on the radiator core support by two bolts inserted through the upper right and left through-holes and screwed into the right and left bolt holes, respectively, and the lower portion is fixable to the radiator core support by engagement of the pin and the wall portion when they move relative each other.

### BACKGROUND OF THE INVENTION

1. Field of the Invention

The present invention relates to a coupling structure of a hood lock, in which the hood lock is coupled on the radiator core support of a motor vehicle for locking an engine hood.

2. Description of the Related Art

A conventional coupling structure of a hood lock is disclosed in Japanese Patent Laid-Open No. (Tokkai) 2003-120100. This coupling structure of the hood lock includes a radiator core support attached to a vehicle body and a hood lock coupled with the radiator core support and capable of engaging with a striker of an engine hood. The hood lock has a latch for engaging with the striker to restrain it in a fully closed state when the engine hood is at a fully closed position. The hood lock is also provided with a secondary latch for restraining the engine hood in a semiclosed state, a release lever integrally formed with the secondary latch, and a spring for biasing the secondary latch toward the striker to engage with each other.

The hood lock is usually formed with three fastener holes at it upper right and left portions and its lower central portion to ensure sufficient fixing stiffness, and coupled with the radiator support by using three bolts inserted into the fastener holes, as described in Japanese Patent Laid-Open No. (Tokkai) 2004-243800.

However, the conventional coupling structures of the hood lock take a lot of trouble in order to couple the hood lock and the radiator core support with each other by fastening three bolts located at the upper right and left portions and the lower central portion of the hood lock. Specifically, bolting at the lower central portion of the hood lock is a troublesome work, since a space formed around the lower central portion is very small for using a tool to tighten the bolt.

Usually, a fastening position of the hood lock on the radiator core support needs height adjustment so that the hood lock and the striker of the engine hood can be engaged with each other at the fully closed position. Accordingly, the hood lock is temporally fastened on the radiator core support for fine-adjusting the fastening position of the hood lock in a vertical direction with respect to the fully closed position of the engine hood in a state where the radiator core support is mounted on the vehicle body. After the fine adjustment, the hood lock is coupled with the radiator core support by fully tightening the bolts. This height adjustment is troublesome, since a heat exchanger or a plurality of heat exchangers, a bumper fascia and other parts surround the lower central portion, whose surrounding space is very small for the bolting work, particularly tightening the bolt at the lower central portion of the hood lock.

It is, therefore, an object of the present invention to provide a coupling structure of a hood lock that overcomes the foregoing drawbacks and can easily couple a hood lock and a radiator core support with each other at its upper right and left portion and its lower portion in an assembly process, ensuring sufficient fixing stiffness of them.

### SUMMARY OF THE INVENTION

According to an aspect of the present invention there is provided a coupling structure of a hood lock comprising a radiator core support having an upper radiator-core support member provided with a right bolt hole and a left bolt hole, a bracket fixed to the radiator core support and having a pin projecting toward the radiator core support from the bracket, and a hood lock having an upper portion and a lower portion, the upper portion being formed with an upper right through-hole and an upper left through-hole, the lower portion being inserted between the radiator core support and the bracket and formed with a lower through-hole surrounded by a wall portion thereof. The hood lock is coupled on the radiator core support so that the upper portion is fastened on the radiator core support by two bolts inserted through the upper right and left through-holes of the hood lock and screwed into the right and left bolt holes of the radiator core support, respectively, and the lower portion is fixable to the radiator core support through the bracket by engagement of the pin of the bracket and the wall portion of the hood lock when the pin and the wall portion move relative each other.

### BRIEF DESCRIPTION OF THE DRAWINGS

The objects, features, and advantages of the present invention will become apparent as the description proceeds when taken in conjunction with the accompanying drawings, in which:

FIG. 1 is an exploded perspective view showing a radiator core support, a hood lock and a bracket used in a coupling structure of the hood lock of a first embodiment according to the present invention;

FIG. 2 is an enlarged perspective view showing the hood lock shown in FIG. 1;

FIG. 3 is an enlarged perspective view showing the bracket with a pin which is attached to the radiator core support shown in FIG. 1;

FIG. 4 is an enlarged perspective view showing the pin of the bracket shown in FIGS. 1 and 3;

FIG. 5 is an enlarged sectional side view of the bracket with the pin, taken along the line S5-S5 in FIG. 3;

FIG. 6 is a perspective view showing the coupling structure in which the hood lock and the bracket are coupled with the radiator core support;

FIG. 7 is a perspective view showing the radiator core support and the bracket before they are assembled with each other and the hood lock is coupled on the radiator core support;

FIG. 8 is a perspective view showing the radiator core support and the bracket after they are assembled with each other and before the hood lock is coupled on the radiator core support;

FIG. 9 is a perspective view showing the radiator core support coupled with the bracket and the hood lock in a state that the hood lock is temporally assembled with the radiator core support by the pin without bolts;

FIG. 10 is an enlarged sectional side view of a bracket with a pin used in a coupling structure of a hood lock of a second embodiment according to the present invention; and

FIG. 11 is an enlarged sectional side view of a bracket with a pin used in a coupling structure of a hood lock of a third embodiment according to the present invention.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

Hereinafter, a first embodiment of the present invention will be described based on the drawings.

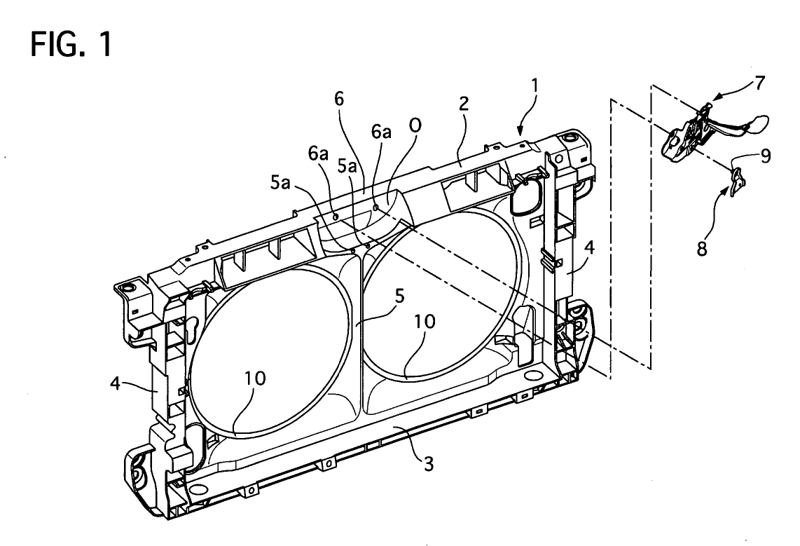

As shown in FIG. 1, a coupling structure of a hood lock of the first embodiment includes a radiator core support 1, a bracket 8 fixed on the radiator core support 1, and a hood lock 7 coupled on the radiator core support 1 between the radiator core support 1 and the bracket 8.

The radiator core support 1 is mounted on a front potion of a not-shown vehicle body. The radiator core support 1 has an upper radiator-core support member 2, a lower radiator-core support member 3 arranged in parallel to and under the upper radiator-core support member 2, right and left side radiator-core support members 4 and 4 respectively connecting the both edge portions of the upper and lower radiator-core support members 2 and 4, and a hood lock stay 5 connecting the central portions of the upper and lower radiator-core support members 2 and 4. Theses members 2, 3, 4 and the hood lock stay 5 are integrally formed of plastic by using plastic injection molding.

The radiator core support 1 has openings 10 and 10 at its both sides, respectively. In each opening 10, a not-shown fan driven by an electric motor is disposed for cooling a radiator core and a condenser core mounted thereon.

The upper radiator-core support member 2 is formed like a letter U in section, opening backward when the radiator core support is mounted on the vehicle body, and provided with a pitted portion at its central position. The pitted portion forms a space O, opening forward, for receiving the hood lock 7 and is formed with right and left bolt holes 6a and 6a for coupling the hood lock 7 on the upper radiator-core support member 2.

The hood lock stay 5 is formed with right and left through-holes 5a and 5a for fastening the bracket 8 thereon at its portion connected with the upper radiator-core support member 2.

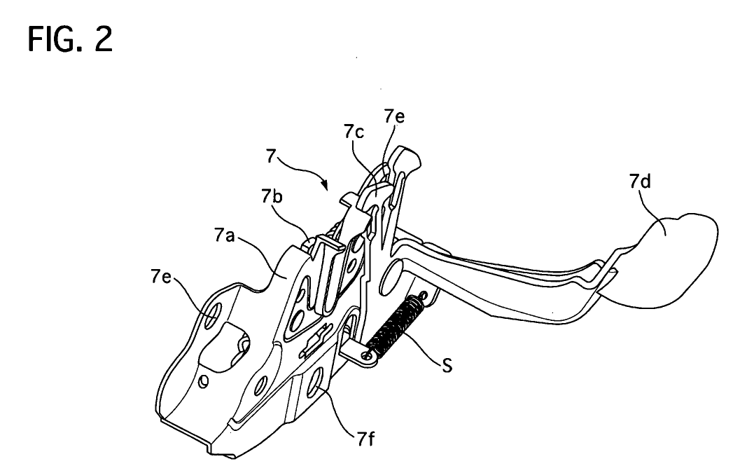

Referring to FIG. 2, there is shown the hood lock 7, which includes a hood-lock main body 7a, a latch 7b for engaging with a not-shown striker of an engine hood to restrain it in a fully closed state at a fully closed position of the engine hood, a secondary latch 7c for restraining the engine hood in a semiclosed stat of the engine hood, a release lever 7d integrally formed with the secondary latch 7c for manually releasing its lock, and a spring S for biasing the secondary latch 7c toward the striker so that they can engage with each other. All parts of the hood lock 7 are made of metal.

The hood lock 7 is provided with upper right and left through-holes 7e and 7e on its upper portion and a lower through-hole 7f on its central lower portion. These upper and lower through-holes 7e and 7f are elongate holes extending in a vertical direction. Positions of the upper right and left through-holes 7e and 7e are aligned are set to correspond to those of the right and left bolt holes 6a and 6a of the radiator core support 1, respectively, when they are assembled with each other.

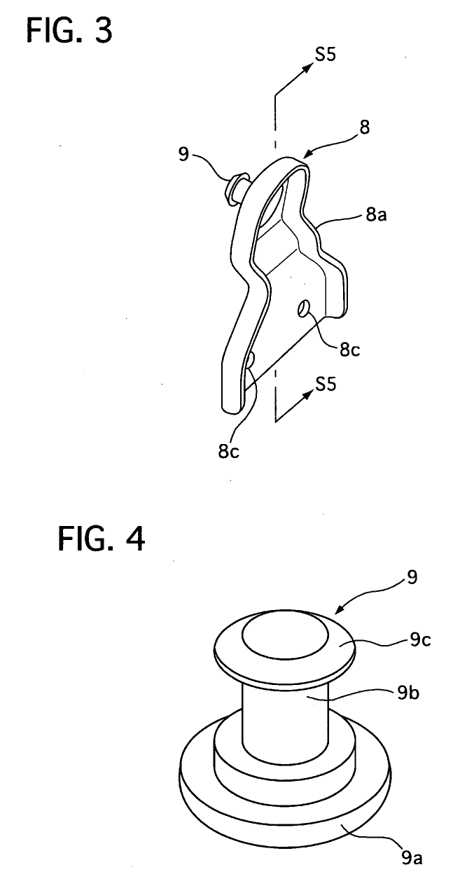

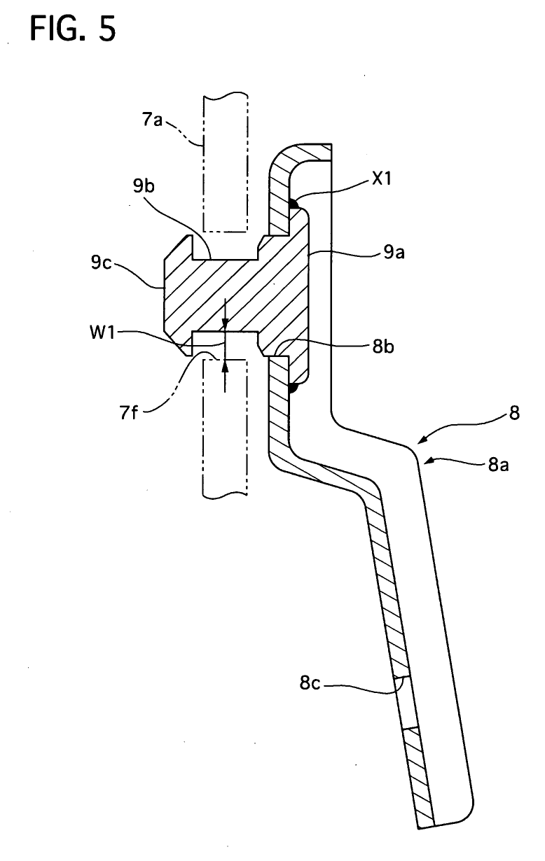

Referring to FIGS. 3 and 5, there is shown the bracket 8. The bracket 8 has a bracket main body 8a, which is formed with an attachment-hole 8b on its upper portion and right and left through-holes 8c and 8c on its lower portion. Positions of the right and left through-holes 8c and 8c are set to correspond to those of the right and left through-holes 5a and 5a of the hood lock stay 5, respectively, when they are fixed to the radiator core support 1.

On the upper portion, a pin 9 is fixed by welding, which is inserted into the attachment-hole 8b and projecting backward from the bracket 8 in a horizontal direction when the radiator core support 1 with the bracket 8 is attached to the vehicle body. The bracket 8 and the pin 9 are made of metal.

As shown in FIG. 4, the pin 9 has a seat 9a consisting of a seating portion larger in diameter than the attachment-hole 8a and an inserting portion substantially equal in diameter to the attachment-hole 8a and insertable therein, a top portion 9c smaller than in diameter than the attachment-hole 8a, and a engagement portion 9b smaller in diameter than the top portion 9c and connecting the top portion 9c and the inserting portion of the seat 9a. The seat portion of the seat 9a is welded at X1 onto the bracket 8 in a state where the inserting portion is inserted into the attachment-hole 8a of the bracket 8 as shown in FIG. 5.

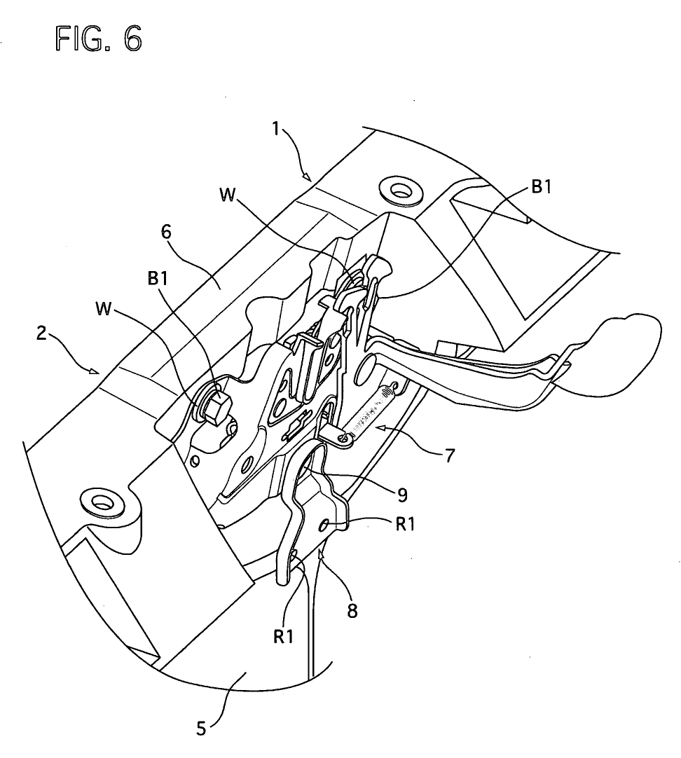

Referring to FIG. 6, there is shown the coupling structure of the hood lock, in which the bracket 8 with the pin 9 is fixed to the radiator core support 1 by rivets R1 and R1 inserted through the right and left through-holes 8c and 8c of the bracket 8 and the right and left through-holes 5c and 5c of the hood lock stay 5, respectively. In this state, the pin 9 extends from the bracket 8 toward the heat exchanger core support 1, forming a gap between the top portion 9c of the pin 9 and the radiator core support 1.

The hood lock 7 is coupled on the pitted portion of the radiator core support 1 by two bolts B1 and B1 inserted through washers W and the upper right and left through-holes 7e and 7e and screwed into the right and left bolt holes 6a and 6a of the radiator core support 1.

The pin 9 of the bracket 8 is inserted into the lower through-hole 7f of the 20 hood lock 7 when the hood lock 7 and the bracket 8 are coupled with the radiator core support 1 so that the pin 9 and an wall portion forming the lower through-hole 7f of the hood lock 7 can be engaged with each other to ensure sufficient fixing stiffness in the vertical direction of the hood lock 7 when the engine hood is pulled upward. Note that the pin 9 and the wall portion may be set whether they are in contact with each other or in non-contact with each other when the engine hood is not pulled up. In addition, the pin 9 and the wall portion can engage with each other in a horizontal direction, but horizontal force applied to them is smaller than vertical force applied to them.

The coupling structure of the hood lock is assembled as follows.

First, the radiator core support 1, the hood lock 7, the bracket 8 and others, such as the rivets R1, the bolts B1 and the washers W are prepared.

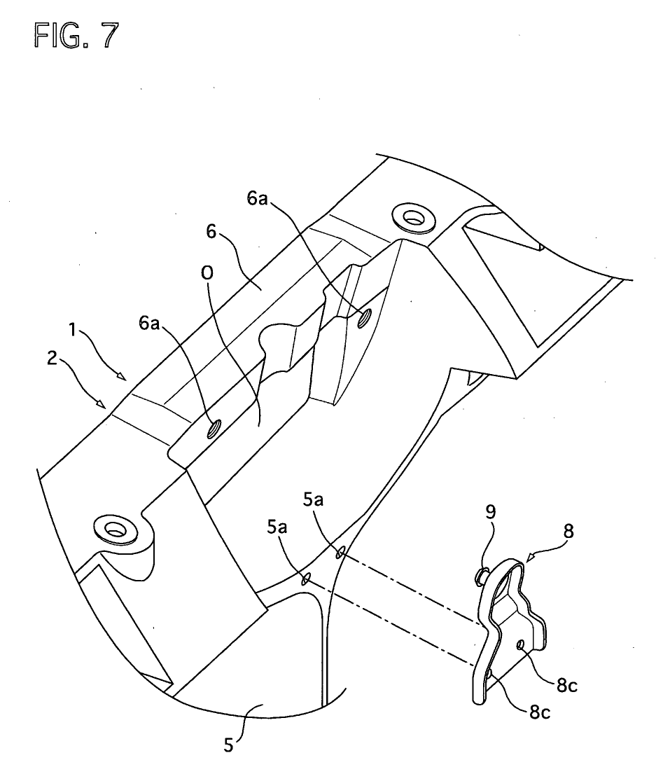

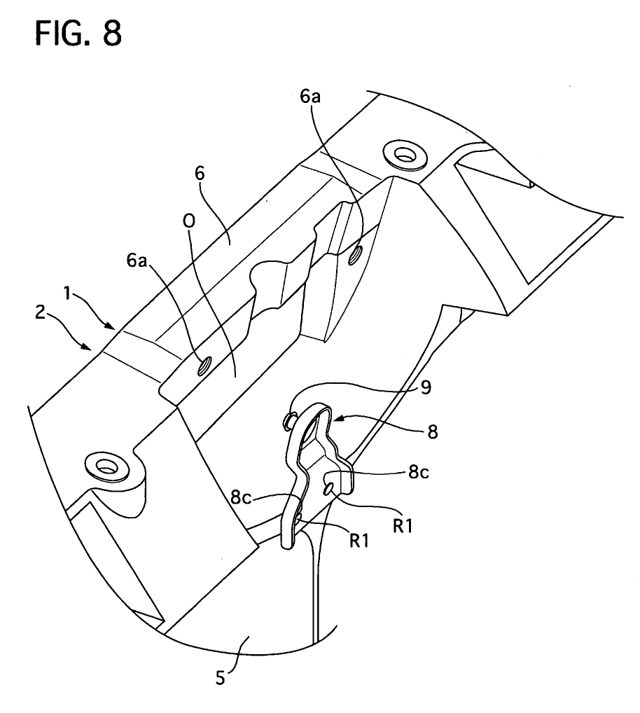

Next, the bracket 8 is, as shown in FIG. 7, positioned so that the positions of the right and left through-holes 8c and 8c of the bracket 8 can correspond to those of the right and left through-holes 5a and 5a of the hood lock stay 5, respectively. The right and left rivets R1 and R1 are inserted into the right through-holes 8a and 5a and the left through-holes 8a and 5a, respectively, and their top portions are caulked to fix the bracket 8 to the radiator core support 1 as shown in FIG. 8.

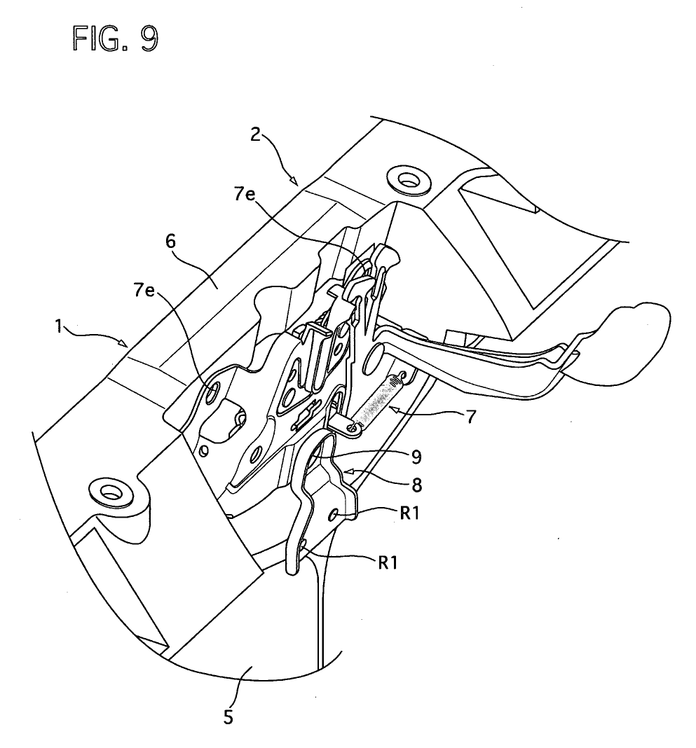

Next, the hood lock 7 is inserted diagonally into the pitted portion so that the upper right and left through-holes 7e and 7e of the hood lock 7 can correspond to the right and left bolt holes 6a and 6a of the radiator core support 1, respectively. The hood lock 7 is rotated and stood erect, as shown in FIG. 9, so that the pin 9 of the bracket 8 is inserted into the lower through-hole 7f of the hood lock 7 as shown in FIG. 5. In this state, although a vertical gap W1 is generated between a lower surface of the engaging portion 9b of the pin 9 and the wall portion forming the lower through-hole 7f of the hood lock 7, they contact with each other when they move relative to each other in the vertical direction.

In this state, the pin 9 can temporally hold the hood lock 7, thereby preventing the hood lock 7 from being fallen from the radiator core support 1 during their delivery in a radiator core support assembly line.

Then, the hood lock 7 is fastened to the radiator core support 1 by the right and left bolts B1 and B1, which are inserted through the right and left washers W and W and the upper right and left through-holes 7e and 7e of the hood lock 7 and screwed into the right and left bolt holes 6a and 6a of the radiator core support 1, respectively.

The two bolts B1 are temporally tightened before the vertical adjustment of the hood lock 7, which is performed allowing for a position relationship between the hood lock 7 and the engine hood after the radiator core support 1 is mounted on the vehicle body. After finishing the adjustment, the bolts B1 are fully tightened.

The coupling structure of the hood lock 7 of the first embodiment has the following advantages.

The hood lock 7 is coupled at its upper portion on the radiator core support 1 lo by two bolts B1 and by the wall portion at its lower side being engageable with the pin 9 of the bracket fixed to the radiator core support 1. This can provide sufficient fixing stiffness in the vertical direction, preventing the hood lock 7 to be torn off from the radiator core support 1, when the engine hood is pulled upward. In addition, coupling the lower portion of the hood lock 7 on the radiator core support 1 does not need a bolting. This removes a bolting work in the small space around the lower portion of the hood lock 7, decreasing the manufacturing process and cost.

Next, a coupling structure of a hood lock of a second embodiment according to the present invention will be described with reference to the accompanying drawing.

A configuration of a bracket with a pin is set arbitrarily. The second embodiment is an example of its modification.

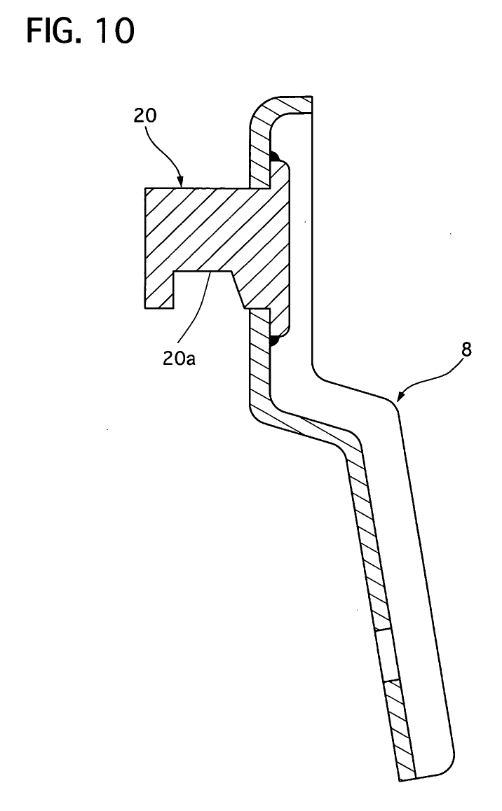

As shown in FIG. 10, in the coupling structure of the hood lock of the second embodiment, a bracket 8 is provided at its top portion with a pin 20, which has a circular cylinder portion and a seat. The circular cylinder portion is formed smaller in diameter than a lower through-hole of the hood lock and projected from the bracket 8 in a horizontal direction and The circular cylinder portion is formed like a key in section to have a notch 20a therein. The seat is formed larger in diameter than the lower through-hole of the hood lock and is welded on the bracket 8. The other parts are similar to those of the first embodiment.

This key-like shaped pin 20 can improve fasten performance between the pin 20 and a not-shown hood lock.

Next, a coupling structure of a hood lock of a third embodiment according to the present invention will be described with reference to the accompanying drawing.

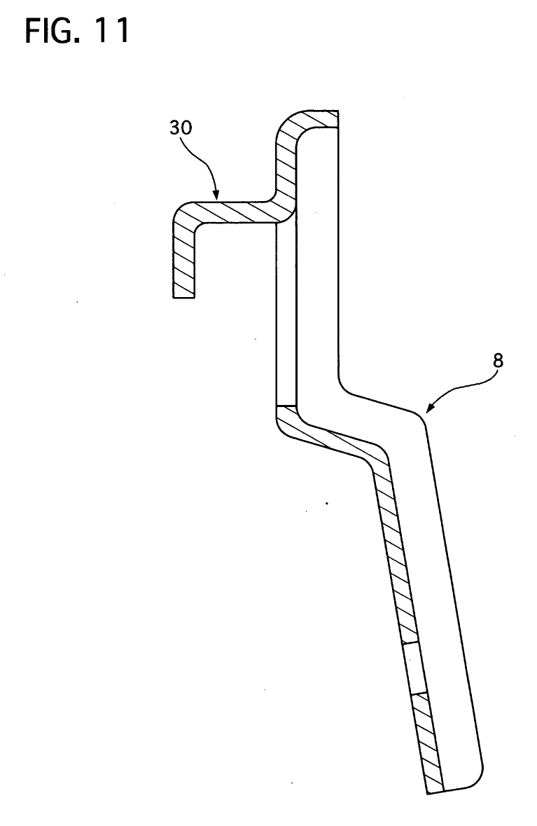

As shown in FIG. 11, in the coupling structure of the hood lock of the second embodiment, a bracket 8 and a pin 30 are integrally formed by using press working. A part of an upper portion of the bracket 8 is partially cut off and folded backward and its top portion is folded downward to form the pin 30 in a key-like shape. The other parts are similar to those of the first embodiment.

This bracket 8 with the pin 30 can decrease its manufacturing process and cost.

While there have been particularly shown and described with reference to preferred embodiments thereof, it will be understood that various modifications may be made therein, and it is intended to cover in the appended claims all such modifications as fall within the true spirit and scope of the invention.

For example, the radiator core support 1 may be made of metal material and plastic instead of using only plastic.

The bracket 8, the pin 9 and the radiator core support 1 may be integrally formed by using plastic injection molding or metal press forming.

The entire contents of Japanese Patent Application (Tokugan) No. 2005-122860 filed Apr. 20, 2005 is incorporated herein by reference.

What is claimed is:

1. A coupling structure of a hood lock comprising:
a radiator core support having an upper radiator-core support member provided with a right bolt hole and a left bolt hole;
a bracket fixed to the radiator core support and having a pin projecting toward the radiator core support from the bracket; and
a hood lock having an upper portion and a lower portion, the upper portion being formed with an upper right through-hole and an upper left through-hole, the lower portion being inserted between the radiator core support and the bracket and formed with a lower through-hole surrounded by a wall portion thereof, wherein
the hood lock is coupled on the radiator core support so that the upper portion is fastened on the radiator core support by two bolts inserted through the upper right and left through-holes of the hood lock and screwed into the right and left bolt holes of the radiator core support, respectively, and the lower portion is fixable to the radiator core support through the bracket by engagement of the pin of the bracket and the wall portion of the hood lock when the pin and the wall portion move relative each other.

2. The coupling structure of the hood lock of claim 1, wherein
the pin is connected wit the bracket.

3. The coupling structure of the hood lock of claim 2, wherein
the pin includes a seat larger in diameter than the lower through-hole of the hood lock, a top portion smaller in diameter than the lower through-hole, and an engaging portion smaller in diameter than the top portion and engageable with the wall portion of the hood lock.

4. The coupling structure of the hood lock of claim 2, wherein
the pin is notched to have a key-like shape.

5. The coupling structure of the hood lock of claim 2, wherein
the bracket has a right through-hole and a left through-hole under the pin, the bracket being fixed to the radiator core support by two rivets inserted through the right and left through-holes, respectively.

6. The coupling structure of the hood lock of claim 1, wherein
the pin and the bracket are integrally formed with each other.

7. The coupling structure of the hood lock of claim 6, wherein
the pin is formed by partially cutting off the bracket and folding a cutting-off portion of the bracket.

8. The coupling structure of the hood lock of claim 6, wherein
the bracket has a right through-hole and a left through-hole under the pin, the bracket being fixed to the radiator core support by two rivets inserted through the right and left through-holes, respectively.

9. The coupling structure of the hood lock of claim 1, wherein
the pin includes a seat larger in diameter than the lower through-hole of the hood lock, a top portion smaller in diameter than the lower through-hole, and an engaging portion smaller in diameter than the top portion and engageable with the wall portion of the hood lock.

10. The coupling structure of the hood lock of claim 9, wherein
the bracket has a right through-hole and a left through-hole under the pin, the bracket being fixed to the radiator core support by two rivets inserted through the right and left through-holes, respectively.

11. The coupling structure of the hood lock of claim 1, wherein
the pin is notched to have a key-like shape.

12. The coupling structure of the hood lock of claim 11, wherein
the bracket has a right through-hole and a left through-hole under the pin, the bracket being fixed to the radiator core support by two rivets inserted through the right and left through-holes, respectively.

13. The coupling structure of the hood lock of claim 1, wherein
the pin is formed by partially cutting off the bracket and folding a cutting-off portion of the bracket.

14. The coupling structure of the hood lock of claim 13, wherein
the bracket has a right through-hole and a left through-hole under the pin, the bracket being fixed to the radiator core support by two rivets inserted through the right and left through-holes, respectively.

15. The coupling structure of the hood lock of claim 1, wherein
the bracket has a right through-hole and a left through-hole under the pin, the bracket being fixed to the radiator core support by two rivets inserted through the right and left through-holes, respectively.
